(19) United States
(12) Patent Application Publication
(10) Pub. No.: US 2016/0049036 A1
(43) Pub. Date: Feb. 18, 2016

(54) APPARATUS AND SYSTEM FOR TEMPERATURE-CONTROLLED STORAGE

(71) Applicant: Dommonic NELSON, Houston, TX (US)

(72) Inventor: Dommonic NELSON, Houston, TX (US)

(21) Appl. No.: 14/461,728

(22) Filed: Aug. 18, 2014

(51) Int. Cl. G07F 11/62; G06Q 20/18; F25D 23/06; F25D 13/02; F25D 23/02

(52) U.S. Cl. CPC G07F 11/62; F25D 13/02; F25D 23/02; F25D 23/062; G06Q 20/18

(57) ABSTRACT

The apparatus and system for controlling the temperature of a plurality of separate storage compartments described herein has been made in consideration of the above problems. An exemplary embodiment of such an apparatus includes a centralized refrigeration system that circulates chilled air to these separate storage compartments and a number of heating units located within the apparatus housing but separate from the storage compartments for purposes of user convenience. It also includes a locking mechanism capable of securing food, beverages, and/or medicine stored in the apparatus against unauthorized access. Additional functionality, such as an Internet connection and sufficient instrumentation to allow the status of the storage compartments to be monitored, may also be included in such an embodiment.

### BACKGROUND

Food-related vending machines are now relatively commonplace in various public settings. These vending machines often allow users to choose from a variety of foods and drinks and purchase, at their convenience, any that are to their liking. As such, vending machines are often installed at locations that host large numbers of people for extended periods of time, like schools or workplaces. To the present date, such vending systems have been limited in their functionality and space-inefficient. Typical vending machines are limited to displaying and/or vending various purchasable products, and, when depleted of the products in question, do not make further use of the storage space the depletion of the products has freed up. Typical prior art vending machines also have substantial maintenance requirements, due to having large numbers of moving parts and otherwise; many such vending machines must be serviced on a monthly basis at minimum, a process which generally requires extensive disassembly of the vending machine. Additionally, most known vending machines must be replenished after purchasable consumables have been sold, which generally must take place on an uncertain or arbitrary time schedule and which may also require extensive disassembly of the vending machine.

Furthermore, many people may prefer to thing their own food to eat instead of having to order food from a vending machine; for example, they may be dissatisfied with the selection at the vending machine, or may find the vending machine prices too expensive. These people are usually faced with the question of where to store their food until they eat it, how to keep the food cold, and how to warm up any of their food that they wish to eat hot. Additionally, for people who are visiting a location which they do not often frequent, they may end up carrying their food with them for half a day or more due to lack of a practically useful place to store the food. Users who have other items that they wish to keep cold, for example beverages or medicines, may face similar problems.

Some locations provide communal refrigerators and/or microwaves in small kitchenettes. This is common in many office workplaces, but those office workers are used to the also-common problems when another person takes (either accidentally or purposefully) their food and/or drink, or even their medicine. Such communal kitchenettes are also not practical in public spaces due to the lowered security for personal belongings kept in such kitchenettes.

In many public spaces, personalized storage is available, for example individual lockers at an airport or train station for the temporary storage of personal effects. However, these lockers have no temperature control associated with them; many foods, beverages, or medicines requiring a cooler temperature, such as milk or frozen products, would not keep in such a locker. Additionally, someone utilizing these public lockers is still faced with the question of how to warm up his or her food.

There is a need for an improved, user-friendly food, beverage, and/or medicine storage device. Current methods are spatially inefficient, impractical, or non-existent, depending on the environment.

### SUMMARY

An apparatus and system for controlling the temperature of any number of separate storage compartments. An exemplary embodiment of such an apparatus may include a plurality of separate storage compartments located within a larger housing. The housing may include a centralized refrigeration system that circulates chilled air to these separate storage compartments, and may include an exterior door through which the storage compartments may be accessed. The embodiment also may include a locking mechanism to prevent unauthorized access to the storage compartments. A further exemplary embodiment may include the above, and additionally may include a plurality of storage compartment access doors separate from the exterior door and a mechanism for heating food located within the housing of the apparatus.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

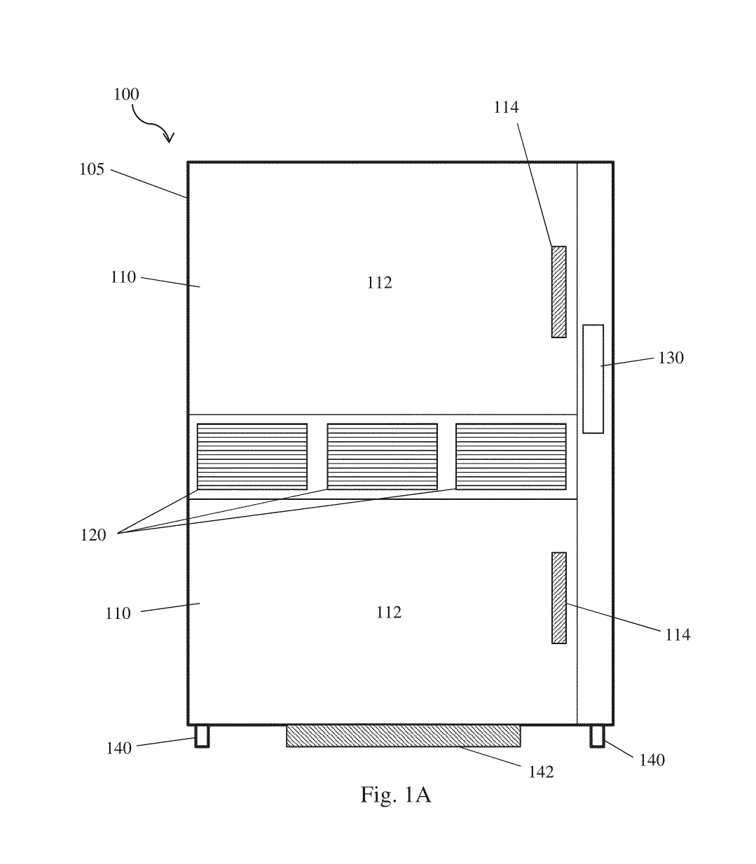

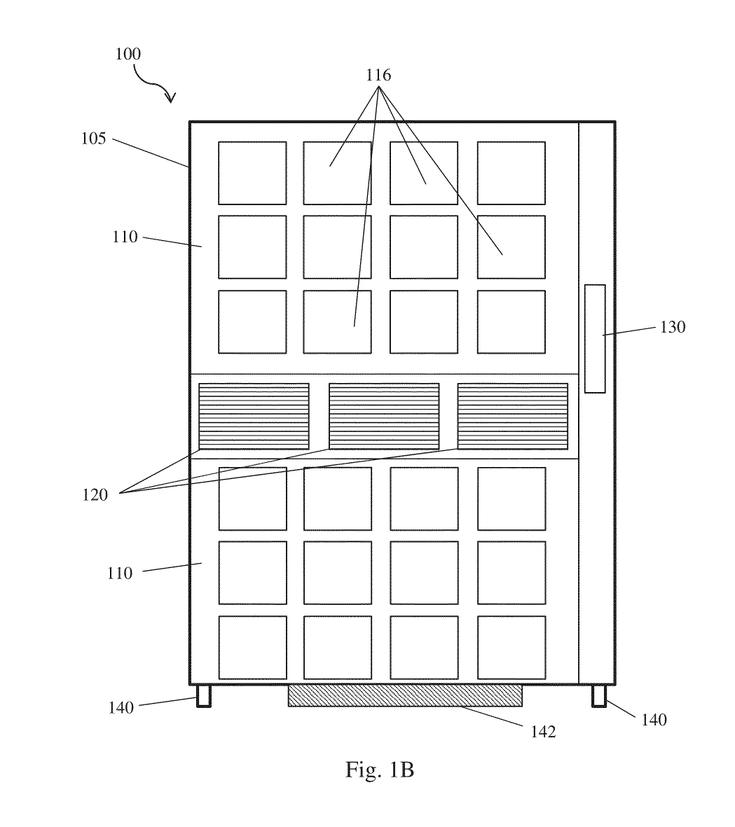

Exemplary FIG. 1A shows the front side of an exemplary embodiment of a temperature-controlled storage system with exterior doors closed and in place;

Exemplary FIG. 1B shows an alternate view of the exemplary embodiment of FIG. 1a, showing the front side of the temperature-controlled storage system with exterior doors open or removed and with the individual storage elements exposed;

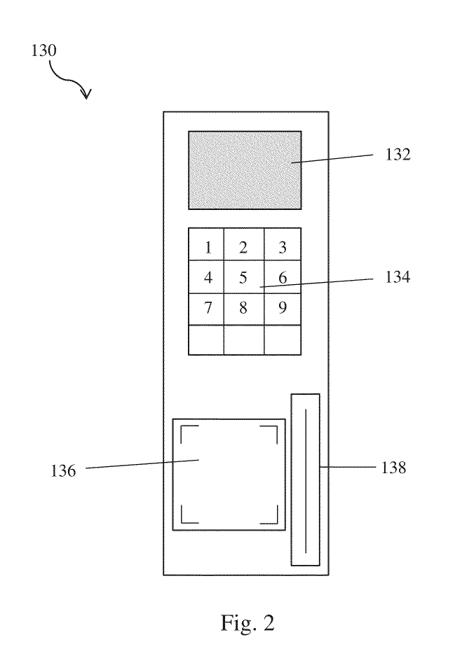

Exemplary FIG. 2 shows a detail view of an exemplary embodiment of an access pad;

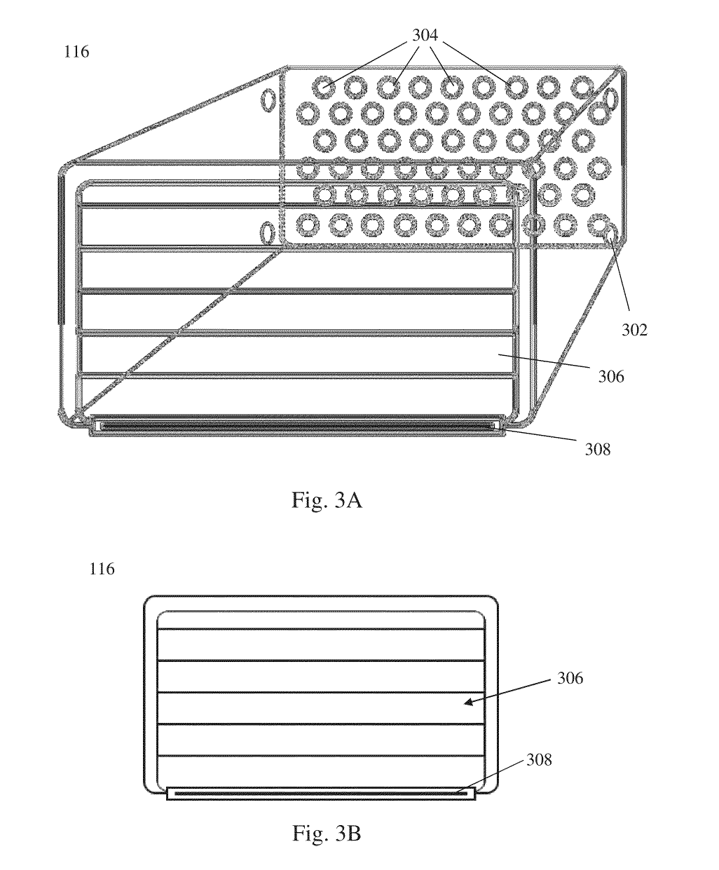

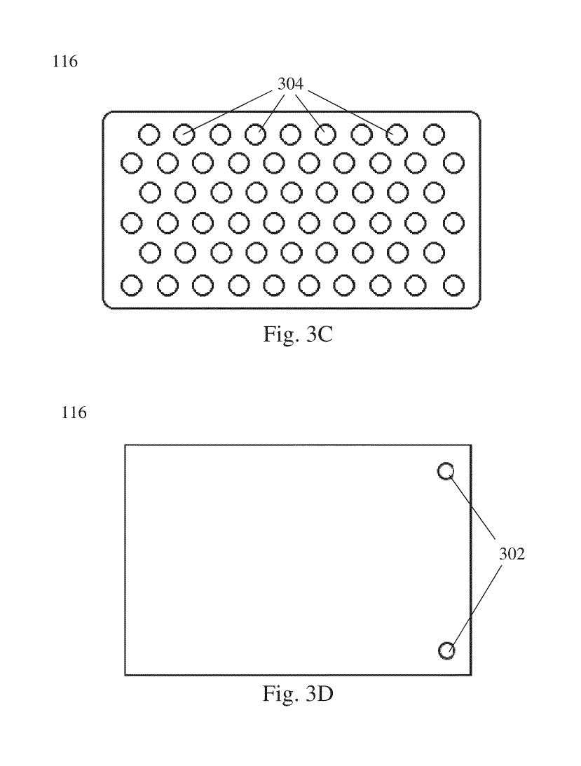

Exemplary FIG. 3A shows a three-dimensional view of an exemplary embodiment of a single individual storage element;

Exemplary FIG. 3B shows an alternate view of the exemplary embodiment of FIG. 3A, showing the front side of the individual storage element.

Exemplary FIG. 3C shows an alternate view of the exemplary embodiment of FIG. 3A, showing the rear side of the individual storage element.

Exemplary FIG. 3D shows an alternate view of the exemplary embodiment of FIG. 3A, showing a side view of the individual storage element.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a temperature-controlled storage apparatus and system may be described. The temperature-controlled storage system can include a centralized refrigeration system that circulates chilled air to these separate storage compartments and any number of heating units, e.g. microwaves, microwaving capabilities, toasters, toasting capabilities, or any other heating apparatus or capabilities, as desired, located within the apparatus housing but separate from the storage compartments. The heating units may be directly open to the environment, secured behind one or more doors, or otherwise positioned or disposed amongst the compartments, as desired. Other devices or equipment for preserving or preparing food may be used in place of, or in conjunction with, the chilled air system in the storage compartments and the heating system. As one example, instead of using a chilled-air system, a vacuum pump could be used to create vacuum conditions within the storage compartments, thereby creating a desirable environment for long-term food storage. As another example, an apparatus intended to vend produce might use a food processor in place of a heating unit.

A further exemplary embodiment can also include a locking mechanism capable of securing food, beverages, or medicine stored in the apparatus against unauthorized access. Users that are authorized to access food or other items within one of the storage compartments, for example food that they have stored within the apparatus, or food that they have paid for, may be able to identify themselves and properly gain access to the item or items by presenting some form of identification or verification. For example, users could identify themselves electronically, such as through use of a bar code reader system or by entering a code via a numerical keypad. According to an exemplary embodiment, users may be able to provide additional documentation either physically or electronically to access an it or items that they could not otherwise access; for example, a temperature-controlled storage system may be configured as a vending machine to dispense medicine, and may restrict the purchase of certain medicines to users who have input valid prescription information.

The exemplary embodiments described herein may offer any of a variety of additional functionality, such as online functionality that allows users or administrators to remotely view the state of the apparatus. Administrators and users may be able to use the online functionality of the apparatus to determine whether or not storage compartment is currently occupied or in use and other information, such as how long the storage compartment has been occupied. Further, online or network-implemented access may provide payment capabilities or allow for other charges associated with the use of the compartments to be paid.

Referring generally to exemplary FIGS. 1A and 1B, a storage system 100 may include one or more storage sections 110, and one or more heating units 120, all contained within a housing 105. Storage sections 110 may be accessed by at least one exterior door 112 that can also include handle 114, and which may be secured by a locking mechanism. Exterior door(s) 112 may be transparent, translucent, or opaque, or may have any other known or desired appearance, and may be flat, curved, semicircular, or any other shape, as desired. Exterior door(s) on the same storage system may have different appearances or shapes, as desired; according to one embodiment, opaque French-style doors may be used to enclose storage sections 110, and a transparent sliding door used to enclose the heating units 120. Opening an exterior door 112 may allow access to individual storage compartments 116. Exemplary FIG. 1B may show a front view of storage system 100 with exterior doors 112 removed for simplicity. In the preferred embodiment, the storage system 100 may include distinct upper and lower exterior doors 112 separated by a single central row of heating units 120.

Individual storage compartments 116 may be arranged in any desired fashion, and may be sized, shaped, or given internal features or compartmentalization for a particular application; for example, they may be specifically sized to provide sufficient room for a meal that may an individual has prepared and stored in a small cooler or other type of food carrying and transportation device, or may be shelved to improve organization. Different individual storage compartments 116 within the same storage system 100 may have different or adjustable size, shape, internal features or compartmentalization; for example, in an embodiment of a storage system 100 that is configured to vend produce, more delicate or more easily damaged produce may be stored in a more protective individual storage compartment 116 specifically tailored to vend that type of produce, while less delicate consumables may be stored in general-purpose individual storage compartments 116. Additionally, each of individual storage compartments 116 may have its own access door and/or access mechanism separate from exterior door 112, and may have locking mechanisms instead of or in addition to that of the exterior door 112. Individual storage compartments 116 can further be provided with some form of visual indicia, for example an LED, an LCD display, or a mechanical indicator, that can provide an indication of whether or not the compartment is in use.

Further, individual storage compartments 116 may be temperature-controlled. For example, individual storage compartments 116 may be capable of refrigerating their contents. This may be accomplished in any temperature-control fashion known in the art. According to at least one embodiment, cooled air may be circulated through individual storage compartments 116 to keep them a lowered temperature. Additionally, circulating air may provide ventilation for individual storage compartments 116. Individual storage compartments may be optimized to allow for ease of heat transfer and/or ventilation, for example being made permeable to airflow or being constructed from a conductive material. As an alternative example, individual storage compartments 116 may be separately insulated and may be paired with their own temperature-control systems, allowing for different storage compartments to be maintained at different temperatures. These temperatures may be preset, or may be adjustable by the users or other parties as desired.

Heating units 120 may be any suitable cavity configured to heat its contents, for example a microwave, a toaster oven, a hot plate, or any other heating element desired. Heating units 120 and storage sections 110 may be arranged in any of a number of ways in storage system 100. For example, as shown in exemplary FIG. 1A, heating units 120 may be arranged horizontally between two storage sections 110. In other configurations, the heating units 120 may be vertically stacked between two storage sections, may be vertically stacked on one side of the storage system 100, may be arranged such that they are interspersed with individual storage compartments 116, or any other configuration desired.

Other features of storage system 100 may include an access pad 130 and support structures 140. Access pad 130 may provide an interface for a user to unlock exterior door 112 and/or the door to an individual storage compartment 116, and may additionally allow a user to actuate open either door. Access pad 130 may for example include such features as a display, a keypad, a payment system, a bar code scanner, or any other suitable interface device desired. Support structures 140 may provide support to storage system 100, including raising storage system 100 off the floor. Additionally, storage system 100 may include a footstep 142, which may assist users with shorter heights to access components situated higher on storage system 100, or may include other comparable features to improve the accessibility of the apparatus.

Now referring to exemplary FIG. 2, access pad 130 may have one or more interface components for a user to interact with storage system 100. Access pad 130 may have a display 132, a keypad 134, a bar code scanner 136, a payment system 138, or other suitable interface devices. Display 132 may be a touchscreen display, a standard visual display, or any other display desired. Keypad 134 may be a numeric or alphanumeric keypad, may use a full keyboard, or may use other character sets as desired. Bar code scanner 136 may be capable of reading 1D or 2D barcodes, for example barcodes generated on a user's smart phone or barcodes on a physical tag in the user's possession. Other interface devices known in the art may also be integrated in storage system 100, such as an MD reader/communicator, a fingerprint reader, voice control, or any other interface device, as desired. Payment system 138 may be a credit card reader, a bill acceptor, a wireless antenna enabling users to pay via a mobile phone, or any other system for receiving payment.

Now referring generally to exemplary FIGS. 1A-2, access pad 130 may provide for a user to gain access to an individual storage compartment 116. For example, according to at least one embodiment, a user may approach storage system 100 and via access pad 130 request the usage of an individual storage compartment 116, which may be accomplished by means of scanning an assigned bar code 136, swiping a credit card 138, or using a numerical or alphanumerical keypad 134. Access pad 130 may then validate the user's credentials to ensure that the user is authorized to access the given storage compartment 116; access pad 130 may then send a signal to exterior door 112 and/or to an individual storage compartment 116 to unlock, allowing user to place one or more items into individual storage compartment 116. This individual storage compartment 116 may be selectable by the user, may be randomly selected from a list of available compartments, or may be assigned by another method; according to an exemplary embodiment, certain storage compartments 116 may be restricted to certain users or types of users, such as users with a premium subscription. The respective access door(s) may then lock after re-closing. When the user wishes to withdraw his item(s), he may again request access via access pad 130, which may again validate the user's credentials. Payment, if any, may be accomplished either when the user first requests usage of a compartment or when user requests access to withdraw their item(s), and may be for a set fee or may be based on the amount of time that the user has made use of the compartment. In the event that payment for a certain amount of time is made when the user first requests usage of a compartment and the time expires without the user having retrieved their item(s), the device may be configured to unlock automatically. Payment may be accomplished via payment system 138, via authenticating a user's online membership, or by any other means of facilitating payment desired,

According to another embodiment, the storage system 100 may be configured as a vending machine, and the individual storage compartments 116 pre-stocked with items; according to such an embodiment, the user may be able to select an item using access pad 130 and may be able to pay for it through payment system 138, following which the access pad 130 may send a signal to exterior door 112 and/or to an individual storage compartment 116 to unlock.

Referring generally to exemplary FIGS. 3A-3D, individual storage compartments 116 may have a geometry that permits the circulation of chilled air through the compartments 116. Air may circulate through openings in the side panels 302 of the individual storage compartment 116, through openings in the rear panel 304 of the individual storage compartment, or through openings in the top or bottom panels of the individual storage compartment 116. Air may freely circulate within the individual storage compartment 116 or within only a portion of it. For example, an individual storage compartment 116 may include an adjustable center panel separating a refrigerated portion of the individual storage compartment 116 from a nonrefrigerated or insulated portion of the individual storage compartment 116; this panel, when adjusted, may allow a user to adjust the amount of space allocated to any defined portions within the individual storage compartment 116.

Individual storage compartments 116 may incorporate a compartment door 306, which may be located in place of the front panel or elsewhere; for example, the door 306 may instead replace the top panel of the individual storage compartment 116. This door 306 may be openable via a handle 308 located on the lowermost portion of the door or elsewhere, for example in the center of the door 306 or on the body of the individual storage compartment 116. The door 306 may have a single section or may have several sections connected to each other via hinges, and may open outward or may slide into the individual storage compartment 116 when opened,

Storage compartments 116 may be removable and may be supported within the storage system 100 by rails, shelves, platforms, bars, or by any other appropriate method of supporting. Similarly, the rear side of the storage compartments 116 may be supported when in use by a fall protection wall or bar. In the preferred embodiment, bars or permeable wall panels may be used to support the rear sides of the storage compartments 116 when housed within the storage system 100. According to an alternative exemplary embodiment wherein the temperature of each individual storage compartment 116 is separately controlled and there is negligible air circulation between storage compartments 116, the storage compartments 116 may directly incorporate refrigerating coils into their design and may not be removable from the storage system 100.

Alternative embodiments of the individual storage compartments 116 may have different shapes, sizes, or configurations. For example, according to an alternative embodiment, the individual storage compartment 116 may have a rounded or cylindrical shape, or fewer or more openings or vents to allow more or less air circulation. The geometry of the individual storage compartments 116 may even be adjustable; for example, the volume of air circulation through the storage compartment 116 may be controlled via adjustable vents on the outermost portion of the individual storage compartment 116. In another embodiment, the individual storage compartment 116 may be constructed from a substantially flexible material, for example foam, plastic, or fabric, and may have a more variable geometry because of this construction.

Referring generally to exemplary FIGS. 1A-3D, storage system 100 may incorporate at least one refrigeration system. Such a system may be housed internally, externally, or a combination of the two; in the preferred embodiment, if the system is housed internally, it may be housed between the back panels of the individual storage compartments 116 and the back panel of the storage system 100. The storage system 100 may incorporate a device for operationally connecting the refrigeration system to at leas one power source; for example, the storage system 100 may include an electrical power cord that may be connected to a standard plug outlet. Alternatively, chilled air or chilled refrigerant may be supplied to the storage system 100 by another device; for example, the storage system 100 may be able to connect to a cold water supply and employ water as a refrigerant. The storage system 100 may incorporate more than one power system; for example, the payment system 138 may be powered via battery backup as well as via outlet power.

Again referring generally to FIGS. 1A-3D, storage system 100 may have additional features, as desired for particular applications. For example, storage system 100 may be sized and shaped such that it fits into a location where it is to be used; this may include being sized and shaped similarly to a vending machine or being given a semicircular u-shape. Size and shape may be adjustable; for example, an embodiment of storage system 100 may be adjustable into an L-shape if intended to fit in a corner or between two connecting walls, and may be adjustable into a flatter shape if intended to fit flush against a wall. Such an embodiment may allow for adjustment of the shape of the storage system 100 without impairment to its functionality or accessibility. Furthermore, storage system 100 may include other features that facilitate saving space; for example, an embodiment of the storage system 100 may comprise a modular stack of individual storage compartments 116, heating units 120, and similar compartments which may be added to or removed from the storage system as desired. Such an embodiment may allow owners of the storage system 100 to tailor the storage system 100 to the space they have available.

Storage system 100 may also have additional credential validation functionality or additional anti-theft features; according to at least one embodiment, storage system 100 may include a security camera or another sensing device that may act to identify persons attempting to improperly gain access to individual storage compartments 116 or to other components of the storage system 100. According to another embodiment, users may be subscribed to an account, with each account attached to a single individual storage compartment 116. In this embodiment, a subscribed user may have a storage compartment guaranteed for their use that they may re-access and re-use whenever they so desire. A user may provide identifying information, for example a numeric code or a bar code on his/her smart phone, on his/her lunchbox or other food storage container, on a wallet card, or by another appropriate means, to access the storage compartment. An administrator may be able to access the device through similar means, and may have additional functionality made available to them; for example, the administrator may be able to open all storage compartments in the apparatus to facilitate cleaning or removal of spoiled food, or to allow an apparatus configured as a vending machine to be restocked. According to another embodiment, storage system 100 may be fitted for remote monitoring, for example monitoring via a network, such that a technician may be able to see the status of storage system 100 and potentially manage multiple machines at the same time. A technician may also be able to remotely access an apparatus to facilitate management; for example, they may be able to reserve a storage compartment for a subscribed user. According to another exemplary embodiment, a storage system 100 configured as a vending machine may restrict a subset of its contents to subscribed users, or to a particular set of users; for example, a storage system 100 that is configured to vend alcoholic beverages may restrict sale of these beverages to subscribed users that have been verified to be the appropriate age.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for temperature-controlled storage, comprising:
a housing;
a plurality of separate storage compartments housed in the housing;
at least one mechanism for providing refrigeration to at least one of the storage compartments in the plurality of storage compartments;
at least one exterior door coupled to the housing through which the separate storage compartments can be accessed from outside; and
at least one locking mechanism that limits access to the plurality of storage compartments.

2. The apparatus for temperature-controlled storage of claim 1, further comprising a plurality of storage compartment access doors through which each storage compartment in the plurality of storage compartments is accessed when the at least one exterior door is opened.

3. The apparatus for temperature-controlled storage of claim 1, wherein each of the plurality of storage compartments is formed such that each storage compartment in the plurality of storage compartments is insulated from each of the other storage compartments in the plurality of storage compartments.

4. The apparatus for temperature-controlled storage of claim 1, wherein each of the plurality of storage compartments is formed such that each storage compartment in the plurality of storage compartments is internally porous and allows for air circulation between storage compartments in the plurality of storage compartments.

5. The apparatus for temperature-controlled storage of claim 1, wherein temperatures of the plurality of separate storage compartments are controlled by a temperature regulator that circulates refrigerated air between interior storage compartments.

6. The apparatus for temperature-controlled storage of claim 1, further comprising independent temperature regulators associated with each storage compartment in the plurality of storage compartments.

7. The apparatus for temperature-controlled storage of claim 1, wherein the locking mechanism is operationally linked to a payment system.

8. The apparatus for temperature-controlled storage of claim 1, wherein the locking mechanism is operationally linked to and receives control signals from a numerical keypad.

9. The apparatus for temperature-controlled storage of claim 1, wherein one or more of the plurality of storage compartments are monitored online to determine whether it is occupied or is empty.

10. The apparatus for temperature-controlled storage of claim 1, wherein the apparatus includes heating units disposed in at least one of the plurality of storage compartments.

11. The apparatus for temperature-controlled storage of claim 1, wherein the plurality of storage compartments have further internal compartmentalization.

12. The apparatus for temperature-controlled storage of claim 1, wherein each of the storage compartments in the plurality of storage compartments is operationally linked with a display that indicates whether the compartment is empty or is in use.

13. The apparatus for temperature-controlled storage of claim 1, wherein the lower portion of the apparatus includes a footstep.

14. An apparatus for temperature-controlled storage of food, beverages, and/or medicine, the apparatus comprising:
a housing;
a plurality of separate storage compartments housed in the housing;
at least one exterior door coupled to the housing through which the separate storage compartments can be accessed from outside;
a plurality of storage compartment access doors separate from the at least one exterior door through which the plurality of separate storage compartments may be accessed when the at least one exterior door is open;
at least one electronically controlled locking mechanism;
at least one mechanism for providing refrigeration to at least one of said plurality of separate storage compartments; and
at least one mechanism for heating food.

15. The apparatus for temperature-controlled storage of claim 15, wherein one or more of the plurality of storage compartments are monitored online to determine whether it is occupied or is empty.

16. The apparatus for temperature-controlled storage of claim 15, wherein the electronically controlled locking mechanism is operationally linked to a payment system.

17. The apparatus for temperature-controlled storage of claim 15, where the electronically controlled locking mechanism is operationally linked to and receives control signals from a numerical keypad.

18. The apparatus for temperature-controlled storage of claim 15, where each of the separate storage compartments is operationally linked with a display that indicates whether the compartment is empty or is in use.

19. The apparatus for temperature-controlled storage of claim 15, where the plurality of separate storage compartments have further internal compartmentalization.
